(19) United States
(12) Patent Application Publication
(10) Pub. No.: US 2003/0169674 A1
(43) Pub. Date: Sep. 11, 2003

(54) Data memory

(76) Inventors: Jorn Leiber, Hamburg (DE); Bernhard Mussig, Seevetal (DE)

Correspondence Address: NIXON & VANDERHYE, PC, 1100 N GLEBE ROAD, 8TH FLOOR, ARLINGTON, VA, 22201-4714, US

(21) Appl. No.: 10/311,246

(22) PCT Filed: May 23, 2001
(86) PCT No.: PCT/EP01/05930

(30) Foreign Application Priority Data
Jun. 16, 2000 (DE) 10029702.1

(51) Int. Cl. B29D 17/00

(52) U.S. Cl. 369/272; 264/1.33; 264/1.6

(57) ABSTRACT

The invention relates to a data memory (1) comprising an optical information carrier (10), which has polymer film whose refractive index can be locally altered by heating. The optical information carrier (10) is wound on a reel (12) and is disposed for being unwound from the reel (12) in order to read and write information in the area (14) allocated therefor.

The invention relates to a data memory with an optically writeable and readable information carrier.

D 298 16 802 U1 discloses a data memory with an optically writeable and readable information carrier which comprises a polymer film, whose refractive index can be locally altered by heating. When the polymer film is locally heated with the aid of a write beam, the change of the refractive index leads to a change of the reflecting power (reflectivity) at the relevant position. This can be used for the storage of information. In order to read the information, a read beam is used which is reflected more strongly from positions with increased reflectivity, and this can be measured in order to pick up the information. The polymer film, which, for example, consists of polypropylene (the material for the product marketed by Beiersdorf AG under the designation “tesafilm kristall-klar”), may be prestressed (stretched) in both surface directions during production, so that a high internal energy is stored in the material. Under local heating by the write beam, if the polymer film is configured in this manner, a pronounced material change (densification) takes place as a result of return deformation, and the refractive index is changed in the desired way. In the previously known data memory, an absorber (for example a dye) may be contained in an adhesion layer neighboring the polymer film, which absorber preferentially absorbs the write beam and locally delivers the heat thereby produced to the polymer film. With the aid of an absorber, it is possible to achieve a sufficiently large change of the refractive index (for example a change of about 0.2) even with a relatively low intensity of the write beam.

The polymer film of the previously known data memory is wound spirally in a plurality of plies (for example from 10 to 30 plies) on a winding core, an adhesion layer being arranged between neighboring polymer film plies. By focusing the write beam or read beam, information can be written to a preselected ply of the information carrier and read from it, respectively, in a controlled way.

With the previously known data memory, a relatively large amount of data can admittedly be stored if the number of plies is correspondingly large. This, however, places stringent requirements on the tracking and focusing of the write beam or read beam onto the individual plies, particularly since the plies do not extend circularly, but constitute spiralling turns in which the distance from the central axis of the data memory is not constant over a revolution. A further disadvantage is that the absorption inside the data memory, due to the absorber, increases with the number of plies. This makes the write process, and especially the read process, difficult when the number of plies is large. A data drive suited to the previously known data memory therefore needs to be elaborately designed.

It is an object of the invention to provide a data memory which is based on the storage principle of the previously known data memory, but which, in spite of a relatively large storage capacity, does not present said disadvantages.

This object is achieved by a data memory having the features of claim 1. Advantageous configurations of the invention are given in the dependent claims. Claim 11 relates to a method for producing a data memory.

The data memory according to the invention has an optical information carrier which comprises a polymer film (constituting a polymer carrier), whose refractive index can be locally altered by heating. The optical information carrier is wound on a reel and is designed to be unwound from the reel in order to read and write information in the region intended for this. For being written to and for being read, the data memory is thus handled in a similar way to a magnetic tape, the optical information carrier section unwound from the reel advantageously being wound on a holding reel.

During the reading and writing of information, a read beam or a write beam, respectively, of a drive suited to the data memory needs to pass through only one data carrier ply (or, in a preferred embodiment, actually a plurality of polymer film plies, but advantageously a small number), since the region of the optical information carrier from which data is to be read, or to which data is to be written, is unwound from the reel. This region is fed through the read and write device of the data drive. The requirements in terms of the tracking facilities and the focusing of the read or write beam, respectively, are therefore relatively low, which has a favorable effect on the costs of the drive. Another advantage of the data memory according to the invention is that, in principle, a larger or even much larger amount of data can be stored than in the conventional data memory described in the introduction, since the length of the optical information carrier wound on the reel is virtually unlimited.

An example of a suitable polymer for the polymer film is polypropylene, although other materials are conceivable. The polymer film is advantageously stretched, and a biaxially stretched polypropylene, for example biaxially oriented polypropylene (BOPP), is particularly well suited. The polymer film is biaxially stretched by prestressing it in two mutually perpendicular directions within its plane during production. The effect of this is that a high energy density is stored in the film material. By depositing a comparatively small quantity of energy (quantity of heat) per unit area with the aid of a write beam, it is then possible to obtain a pronounced material change (for example material densification) by return deformation, which results in a local change of the refractive index and a change of the optical path length in the material. The change of the refractive index, in the region which is locally heated by the write beam, is advantageously of the order of 0.2. This leads to a change of the local reflectivity, which can be picked up well with the aid of a read beam.

In a preferred configuration of the invention, the polymer film is assigned an absorber which is designed to absorb a write beam at least partially, and to locally deliver the heat thereby produced at least partially to the polymer film. The absorber may, for example, be contained in an absorber layer arranged on the polymer film, or it may be integrated in the polymer film; hybrid forms are also conceivable. The absorber contains, for example, dye molecules which preferentially absorb at the light wavelength used for the write beam, and it permits local heating of the polymer film which is sufficient to alter the refractive index even with a relatively low intensity of the write beam. One example of an absorber is Disperse Red 1 (DR1), an azo dye which is known from applications in nonlinear optics with polymer films that contain dye. Examples of absorbers with higher thermal stability are anthraquinone dyes or indanthrene dyes. The problem of low transparency due to the absorber, which hinders the read and write processes, is avoided by the fact that the optical information carrier comprises only a single data carrier ply, or only a few data carrier plies, to which an absorber can respectively be assigned, and this is another advantage invention.

As already indicated, the optical information carrier may comprise a plurality of polymer film plies, through which information can be written to a preselected polymer film ply or read from a preselected polymer film ply. Advantageously, an adhesion layer is respectively arranged between neighboring polymer film plies, in order to fix the polymer film plies to one another. In such a data memory, the optical information carrier hence has a plurality of data carrier plies, which respectively comprise a polymer film ply. Besides one or more adhesion layers, additional layers may also be provided, for example absorber layers (see above). With a thickness of between 10 μm and 100 μm for the polymer film of a polymer film ply, the information on different polymer film plies can be mutually separated at good resolution with the aid of, for example, read and write devices known in principle from DVD technology. Thicknesses lying outside the aforementioned range for a polymer film ply are likewise conceivable. An adhesion layer may, for example, have a thickness in the range of between 1 μm and 40 μm. An example of a suitable adhesive is an acrylate bonder which is free from gas bubbles and which, for example, can be crosslinked chemically or by UV or electron radiation.

Advantageously, the refractive index of adhesion layer differs only slightly from the refractive index of the neighboring polymer film plies, in order to minimize perturbing reflections of the read beam or the write beam from a boundary layer between the adhesion layer and a polymer film ply. It is particularly advantageous for the refractive index difference to be less than 0.005. Any difference existing between the refractive indices may, however, be used for formatting the data memory.

When a large number of polymer film plies is used, for a given length of the optical information carrier, the storage capacity of the data memory is commensurately greater. Conversely, if the storage capacity is predetermined, then as the number of polymer film plies increases, there is a reduction in the length of the optical information carrier, and therefore the time for accessing the data memory, when predetermined data are to be read out. On the other hand, as the number of polymer film plies increases, the demands on the read and write device of a data drive become greater, as explained above. For practical purposes, it is therefore important to find a balance between said advantages and disadvantages when setting the number of polymer film plies.

For a data memory in which an adhesion layer is respectively arranged between neighboring polymer film plies, the adhesion layer may comprise an absorber of the type described above. In a particularly preferred embodiment of the invention, an absorber layer is respectively arranged between neighboring polymer film plies and is designed to absorb a write beam at least partially, and to locally deliver the heat thereby produced predominantly to that of the neighboring polymer film plies which lies closest to the focus of the write beam. In this case, an adhesion layer may be designed as an absorber layer. It is, however, also conceivable to provide one or more layers with adhesion properties between neighboring polymer film plies, in addition to the absorber layer; in this case, these layers should be thin compared with the absorber layer, so as not to excessively hinder the heat flux from the absorber layer into the neighboring polymer film ply closest to the focus of the write beam. The structure of the optical information carrier is particularly straightforward and cost-effective if, in all, two polymer film plies are provided and are separated by an absorber layer having adhesion properties, this absorber layer being thick enough to permit predominant heat delivery into one or other of the polymer film plies, according to the position of the focus of the write beam.

In the polymer film, or the polymer film plies, of the data memory according to the invention, the information units are formed by changing the optical properties in a region with a preferred size of less than 1 μm. In this case, the information may be stored in binary form, that is to say the local reflectivity takes only two values at the position of an information unit. This means that, for example, a “1” is stored at the relevant position on the information carrier when the reflectivity lies above a set threshold value, and a “0” is correspondingly stored when it is below this threshold value, or below another lower threshold value. It is however, also conceivable to store the information in a plurality of gray levels. This is possible if the reflectivity of the polymer film at the position of an information unit can be altered in a controlled way by defined adjustment of the refractive index, but without reaching saturation.

In an advantageous method for producing a data memory according to the invention, in which the optical information carrier comprises a plurality of plies or layers, at least two plies or layers are co-extruded. Such plies or layers may, for example, be one or more polymer film plies, one or more absorber layers or one or more adhesion layers. Because a plurality of plies or layers can be manufactured, and advantageously joined to one another, in a single working step during the method, the method can be carried out quickly and cost-effectively.

The invention will be explained in more detail below with reference to exemplary embodiments. In the drawings,

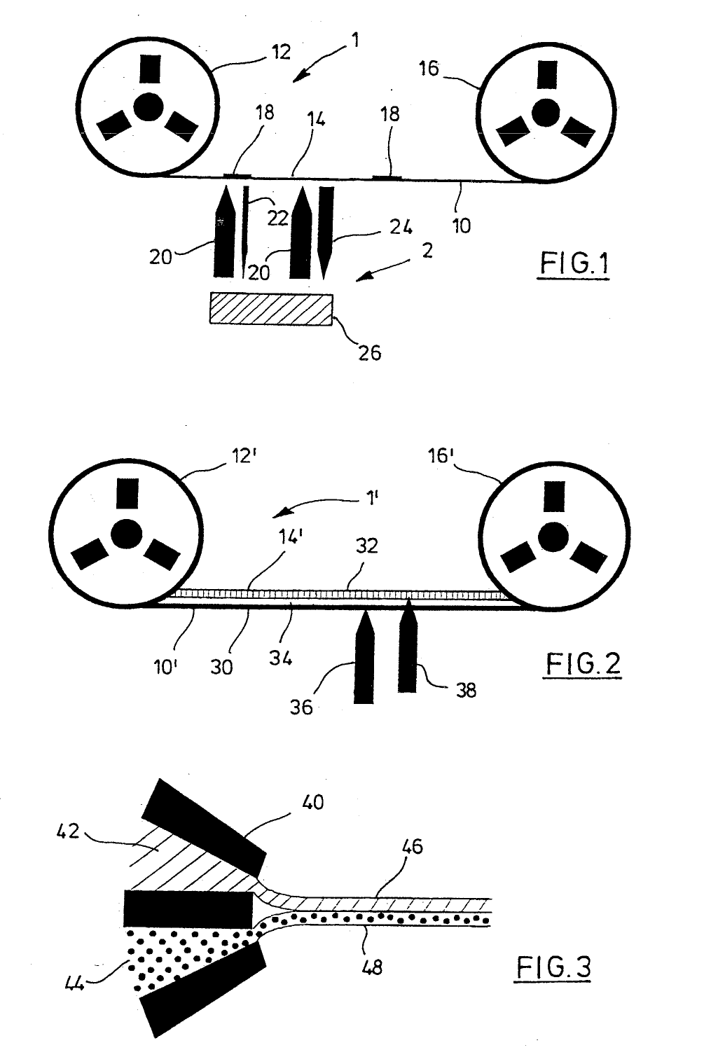

FIG. 1 shows a schematic representation of a data memory according to the invention in a drive suited to it,

FIG. 2 shows a schematic representation of an embodiment of a data memory according to the invention, in which the optical information carrier comprises two polymer film plies, in a drive suited to it, and

FIG. 3 shows a schematic representation of an extruder head, with which a polymer film and an absorber layer can be co-extruded.

FIG. 1 shows, in a schematic way, an embodiment of a data memory 1 which is used in a drive having a write and read device 2.

The data memory 1 comprises a tape-like optical information carrier 10, which is wound on a reel 12. In a region 14 facing the write and read device 2, the optical information carrier 10 is unwound from the reel 12 and extends essentially in a straight line there in the exemplary embodiment. Behind this, the optical information carrier 10 is received on a holding reel 16 and is wound up there. In the exemplary embodiment, the data memory 1 is configured as a cassette, in which the reel 12 and the holding reel 16 are integrated. By means of a control device of the drive, it is possible to carry out forward spooling and rewind spooling, and optionally fast forward spooling and fast rewind spooling, of the reel 12 and the holding reel 16, in order to place a desired region 14 of the optical information carrier 10 in front of the write and read device 2.

In the exemplary embodiment, the optical information carrier 10 comprises a polymer film, onto which an absorber layer is applied, for example in a similar way to that explained below in conjunction with FIG. 3. The polymer film consists here of biaxially oriented polypropylene (BOPP) and has a thickness of 50 μm. The absorber layer contains an absorber dye, which is embedded in an acrylate compound as a binder, and has a layer thickness of 25 μm. Examples of suitable absorber dyes are Disperse Red 1 (in particular for green write lasers) or Rhodamine 800 (in particular for red write lasers). The optical information carrier is 10 mm wide and has a length of 200 m in the exemplary embodiment. Other materials, compositions and dimensions are likewise possible.

The write and read device 2 contains a write and read head, which makes it possible to write information to the optical information carrier 10, or to read it therefrom, and specifically over the full width of the optical information carrier 10 (that is to say in a direction perpendicular to the plane of the paper in FIG. 1). In other configurations, the optical information carrier 10 is divided into tracks which run parallel, in which case only data assigned to a given track can be processed at a given time. The write and read head has optical elements, with the aid of which a light beam (for example with the wavelength 680 nm, 630 nm or 532 nm) produced by a laser, which is not shown in FIG. 1, can be focused onto the optical information carrier 10. A light beam of, for example, 680 nm can be generated by using an inexpensive red laser diode.

In order to store or write information in the data memory 1, the laser is operated with a beam power of about 1 mW in the exemplary embodiment. The laser beam is in this case used as a write beam, and it is focused onto the optical information carrier 10 (advantageously onto the transition region between the polymer film and the absorber layer), so that the beam spot is smaller than 1 μm. The light energy is input in the form of short pulses with a duration of about 10 μs in this case. The energy of the write beam is absorbed in the beam spot, assisted by the absorber, which leads to local heating of the polymer film and therefore to a local change of the refractive index and of the reflectivity, as explained above. In the very embodiment, the reflectivity is reduced during heating by the write beam. In FIG. 1, the positions at which, for example, a logical “0” is written onto the optical information carrier 10 in the described way are labeled by 18 and are schematically indicated with a greatly enlarged width.

In order to read stored information from the data memory 1, the laser is operated in the continuous-wave mode (CW mode) in the exemplary embodiment. The laser beam focused onto the desired position, which is used as a read beam, is reflected as a function of the stored information, and the intensity of the reflected beam is picked up by a detector in the write and read device 2. In FIG. 1, the read process is explained with reference to a logical “0” (left) and with reference to a logical “1” (right). When the read beam denoted, by 20, strikes a position 18 on the optical information carrier 10, a relatively small fraction is reflected, as seen above; a weak reflection 22 results. When, however, the read beam 20 strikes the position of a logical “1”, a larger fraction is reflected, so that a strong reflection 24 results. This is picked up by the detector 26 and processed by the drive, or by the computer in which the drive is located. In FIG. 1, two read beams are indicated next to each other for the sake of illustration; these are, however, the same read beam. During the read process, the polymer film is not significantly heated, so that its refractive index is not thereby changed and the previously written information is preserved.

The data memory may also be of an embodiment which cannot be written to by the user. In this case, it contains information units written by the manufacturer. A write function in the user's data drive is then superfluous.

FIG. 2 shows, in a similar way to FIG. 1, a data memory 1′ which is constructed similarly to the data memory 1, but whose optical information carrier 10′ comprises two plies for the storage of information. The data memory 1′ has a reel 12′ and a holding reel 16′. The region of the optical information carrier 10′ between the reel 12′ and the holding reel 16′ is denoted by 14′ in FIG. 2.

The optical information carrier 10′ contains a first polymer film ply 30 and a second polymer film ply 32, both of which consist of biaxially oriented polypropylene with a thickness of 25 μm in the exemplary embodiment. Between the first polymer film ply 30 and the second polymer film ply 32, there is a 30 μm thick adhesion layer 34, by means of which the two polymer film plies 30 and 32 are flexibly bonded to one another. In the exemplary embodiment, the adhesion layer 34 contains an acrylate bonder, to which an absorber dye is added.

The write and read device of the drive is constructed in a similar way to that described in FIG. 1. Both the write beam and the read beam, however, can be focused selectively with the aid of optics onto the first polymer film ply 30 or the second polymer film ply 32. When the write beam is focused onto the first polymer film ply 30, or onto the adhesion layer 34 in the vicinity of the first polymer film ply 30, as indicated by the reference number 36 in FIG. 2, essentially the first polymer film ply 30 is locally heated, since the write beam 36 is defocused in the region of the second polymer film ply 32 and in the region of the adhesion layer 34 adjacent to it. In this case, for example, a logical “0” is written only into the first polymer film ply 30. Conversely, information can be written to the second polymer film ply 32 by focusing the write beam (reference number 38 in FIG. 2) onto the second polymer film ply 32. In order to read the information, the read beam is focused accordingly.

FIG. 3 illustrates, in a schematic way, how a polymer film is co-extruded with an absorber layer arranged on the polymer film in order to make an optical information carrier 10″ (similar to that of the data memory 1 in FIG. 1.

The extruder used for this has an extruder head 40 with two outlet openings, from which a polymer film 42 (polypropylene in the exemplary embodiment) and an absorber 44 (see below) emerge at elevated temperature. Behind the extruder head 40, these two starting materials converge and form two layers when cooled, namely the polymer film denoted by 46 and the absorber layer denoted by 48. The polymer film 46 and the absorber layer 48 adhere to each another and form the optical information carrier 10. To be more precise, the optical information carrier 10, or the starting material from which the optical information carrier 10 can be cut out, is obtained by biaxially stretching the extrudate after the extrusion. In this way, the polymer film 46 becomes a film of biaxially oriented polypropylene (BOPP), a material in which a high internal energy is stored (see above).

In one example in relation to FIG. 3, the temperature of the extruder head 40 is 120-150° C. A mixture of 0.01-0.1% by weight of the absorber dye Sudan Red B with an acrylate hot melt, as a binder, is used as the absorber 44, that is to say the absorber layer 48 contains the absorber dye Sudan Red B, which is embedded in an acrylate binder. The extrudate is stretched by 500% in the length direction (that is to say in the direction in which the polymer 42 and the absorber 44 emerge from the extruder head 40) and by 700% in the transverse direction. After having been biaxially stretched, the polymer film 46 has a thickness of approximately 20-30 μm and the absorber layer 48 has a thickness of 10-20 μm, so that a total thickness of 30-50 μm is obtained for the optical information carrier.

Depending on the embodiment, other production conditions and other compositions and dimensions for the individual layers are possible. It is also conceivable for additional layers to be provided, which may optionally be co-extruded together with other plies or layers.

In another possible way of making an optical information carrier, the absorber is added to the polymer for the polymer film. The optical information carrier, or its starting material, is then extruded, as a unit comprising the polymer film and absorber, from the polymer which contains the absorber. In one example, a mixture of polypropylene and 0.01-0.1% by weight of the absorber dye Sudan Red B is extruded at a temperature of 120-150° C. The extrudate is then biaxially stretched, specifically by 500% in the length direction (that is to say in the direction in which the mixture of polymer and the absorber dye emerges from the extruder head) and by 700% in the transverse direction. The optical information carrier obtained in this way has a thickness of 30-50 μm and an optical density (see below) of about 0.3. Depending on the embodiment, other production conditions and other mixtures, even of other polymers and absorber dyes, as well as other dimensions, are possible. If the optical information carrier has a plurality of polymer film plies, it is advantageous for the aforementioned unit, comprising the polymer film and the absorber, to be extruded together (co-extrusion) with an adhesion layer (for example of acrylate bonder or lacquer) which does not contain any added absorber dye, and then to be biaxially stretched until a total thickness of, for example, 30-50 μm is obtained. The complete optical information carrier may subsequently be constructed by using a plurality of such layer sequences.

The absorber dye may also be introduced into the polymer film by a diffusion process. In order to carry out the diffusion process, the polymer film may be placed in a solution which contains the absorber. The solvent should, on the one hand, dissolve the absorber and, on the other hand, affect the polymer film in such a way that it takes up the solution and swells. During this, the absorber molecules become distributed in the interior of the polymer film. The polymer film is subsequently removed from the solution, and the solvent is evaporated. During this, the polymer film essentially returns to its original dimensions, with the absorber molecules remaining in the interior of the polymer film.

Another possibility for a diffusion process involves initially converting the absorber into the gas phase, and exposing the polymer film to a gas which contains the absorber. During this, the absorber molecules diffuse into the interior of the polymer film, and some of the absorber molecules remain there as a result of absorption processes.

The absorber Disperse Red 1 (DR1) is suitable for a polymer film made of polypropylene. DR1 is an azo dye which is known from applications in nonlinear optics with polymer films that contain dye. This absorber is preferably added to the polymer film by means of a diffusion process. If, however, the starting material for the optical information carrier is intended to be made by extrusion, using one of the methods explained above, in which case temperatures of the order of 200° C. may be encountered, then absorbers with higher thermal stability, for example anthraquinone dyes or indanthrene dyes, are more suitable than DR1.

Materials other than polypropylene are likewise conceivable for the polymer film. For example, polyethylene terephthalate (PET) may be used, also in conjunction with the absorber dye DR1.

The optical information carrier preferably contains the absorber in an amount or concentration such that an optical density in the range of from 0.1 to 0.3 corresponds to a polymer film ply. The optical density is a measure of the light absorption, here expressed in terms of the light wavelength of a write beam. Depending on the application, however, the optical density may also lie outside this range. In particular when only one or two polymer film plies are employed, higher optical densities offer advantages.

The optical density is a quantity that is very suitable for characterizing the absorption behavior. The following applies for the optical density D:

D=log(1/T)=ε_{λ}c d

Here, T=I/I₀ is the transmission through a layer of thickness d, with the intensity of the incident radiation being reduced from I₀ to I, ε_{λ} is the extinction coefficient at the wavelength λ being used (concentration-independent substance parameter), and c is the concentration of the absorber in the layer.

1. A data memory with an optical information carrier (10) which comprises a polymer film (46), whose refractive index can be locally altered by heating, wherein the optical information carrier (10) is wound on a reel (12) and is designed to be unwound from the reel (12) in order to read and write information in the region (14) intended for this.

2. The data memory as claimed in claim 1, characterized in that the polymer film (46) is stretched.

3. The data memory as claimed in claim 1 or 2, characterized in that an absorber (48) is assigned to the polymer film (46), which absorber is designed to absorb a write beam at least partially, and to locally deliver the heat thereby produced at least partially to the polymer film (46).

4. The data memory as claimed in claim 3, characterized in that absorber is contained in an absorber layer (48) arranged on the polymer film (46).

5. The data memory as claimed in claim 3 or 4, characterized in that absorber is integrated into the polymer film.

6. The data memory as claimed in one of claims 1 to 5, characterized in that the optical information carrier (10′) comprises a plurality of polymer film plies (30, 32), through which information can be written to a preselected polymer film ply (30, 32) or read from a preselected polymer film ply (30, 32).

7. The data memory as claimed in claim 6, characterized in that an adhesion layer (34) is respectively arranged between neighboring polymer film plies (30, 32).

8. The data memory as claimed in claim 7, characterized in that the refractive index of the adhesion layer (34) differs only slightly from the refractive index of the neighboring polymer film plies (30, 32).

9. The data memory as claimed in claim 7 or 8, characterized in that the adhesion layer (34) comprises an absorber which is designed to absorb a write beam at least partially, and to locally deliver the heat thereby produced at least partially to a neighboring polymer film ply (30, 32).

10. The data memory as claimed in one of claims 6 to 9, characterized in that an absorber layer (34) is respectively arranged between neighboring polymer film plies (30, 32) and is designed to absorb a write beam at least partially, and to locally deliver the heat thereby produced predominantly to that of the neighboring polymer film plies (30, 32) which lies closest to the focus of the write beam (36, 38).

11. A method for producing a data memory as claimed in one of claims 1 to 10, in which the optical information carrier (10) comprises a plurality of plies or layers (46, 48), wherein at least two plies or layers (46, 48) are co-extruded.
